(19) United States
(12) Patent Application Publication
(10) Pub. No.: US 2025/0313406 A1
(43) Pub. Date: Oct. 9, 2025

(54) ASSEMBLY FOR AN AUTOMATED STORAGE AND RETRIEVAL SYSTEM

(71) Applicant: Exotec Product France, CROIX (FR)

(72) Inventor: Pierre ROELS, LOMME (FR)

(73) Assignee: Exotec Product France, CROIX (FR)

(21) Appl. No.: 19/169,182

(22) Filed: Apr. 3, 2025

(30) Foreign Application Priority Data
Apr. 5, 2024 (FR) FR2403540

(51) Int. Cl. B65G 1/04

(52) U.S. Cl. CPC B65G 1/0492

(57) ABSTRACT

An assembly including at least one upright extending in a first direction and a toothed bar which includes first teeth; at least one climbing mechanism includes a cogwheel which includes, at its periphery, second teeth adapted to mesh with the first teeth of the toothed bar, the at least one upright and the at least one climbing mechanism includes associated first guiding mechanisms; cooperating with each other over an engagement movement of the climbing mechanism towards the upright in order to guide the cogwheel of the climbing mechanism in the first direction into an engaged position.

### TECHNICAL FIELD

The present description relates to an assembly comprising a cogwheel of a vehicle

climbing means and a toothed bar of a storage rack upright. The present description also relates to a vehicle comprising such a climbing means and a storage rack comprising such an upright.

### BACKGROUND

In the field of logistics, it is known to place storage racks in warehouses. A storage rack in a warehouse typically includes a vertical structure, formed by an assembly of vertical uprights, often in the form of vertical metal profiles.

In warehouses, these storage racks are intended to accommodate and store items, said items then being grouped together to form orders; these orders are subsequently sent to an end customer by means of road or rail transportation, or any other type of transportation, or taken out of the warehouse to be collected directly by the end customer at a “drive”.

Within their structure, storage racks define storage locations, also called cells. These cells are intended to receive bins or more generally containers, in which items are placed and stored. To this end, pairs of mechanical interfaces, typically in the form of brackets, are secured to the uprights, to ensure that the different loads at the level of the different cells are centered and supported.

Such storage racks can be served by a transportation system comprising automatic guided vehicles configured to pick up and drop off items from/into said storage racks. Such storage systems are called ASRS, which stands for Automated Storage and Retrieval System. Automatic guided vehicles, hereinafter referred to by their abbreviation AGV, are robots that move autonomously without human intervention.

AGVs can move in at least one direction, or even both directions, of a horizontal surface which can typically be the warehouse floor. Automatic guided vehicles can also move vertically on storage racks. Such storage systems are disclosed in particular by document WO 2019/072432. As disclosed by this document WO 2019/072432, automatic guided vehicles are configured to pick up containers of products or of articles supported by the brackets in the storage racks, and transport them to another location, typically another storage location, or to an order preparation station where said articles are gathered, typically so as to constitute an order for an end customer.

To this end, the chassis of the automated guided vehicle typically has a prehension device comprising a mobile support, movable relative to the chassis, which is configured to move from a retracted loading position for loading a container (typically a bin) onto the vehicle chassis in which the support is typically housed on the chassis, and to a deployed unloading position in which the mobile support extends cantilevered with respect to the chassis to unload/drop the container, typically onto one of the pairs of brackets of the storage rack.

As disclosed by document WO 2019/072432, said AGVs can have a chassis equipped with climbing means. Typically, these means include motorized cogwheels of the vehicle that are configured to mesh with the links of a substantially tensioned roller chain, or with the teeth of a toothed bar extending along the uprights of the storage racks.

Thus, AGVs have locomotion and orientation means, making them capable of moving in three dimensions. In addition to the two plane dimensions generally associated with the ground on which the AGVs move, there is a third vertical dimension associated with the storage racks on which the AGVs are able to climb and descend.

One of the main challenges in designing these AGVs is to ensure consistent and reliable interaction with the uprights, which is important for the vertical movement of the AGVs. Variations in upright alignment, combined with tolerances in ground flatness and EGV manufacturing, can lead to difficulties in the climbing means meshing. These difficulties are further exacerbated by the lack of real-time control of the engagement mechanism orientation during the meshing process. Such conditions can lead to misalignment and accident hazards.

Document EP-3992115 A1 describes a shuttle-type vehicle moving horizontally along rails in a rack. The vehicle in particular comprises a deployable climbing means for moving the vehicle vertically in the rack along a toothed bar arranged on a first surface of an upright. The climbing means comprises in particular a cogwheel configured to mesh with the teeth of the toothed bar, and a pressure wheel configured to bear on a second surface of the upright facing the toothed, in order to guide the vehicle over its vertical movement. The climbing means also includes a pivoting mechanism for, when the climbing means is deployed, pivoting the cogwheel and the pressure wheel between a released position in which the cogwheel and the pressure wheel are not in contact with either the toothed bar or the second surface of the upright, respectively, and an engaged position in which the cogwheel and the pressure wheel are in contact with the toothed bar and the second surface of the upright, respectively. This pivoting mechanism does not, however, ensure the meshing of the cogwheel with the teeth of the toothed bar.

### SUMMARY

An assembly is provided, comprising:
at least one upright for a storage rack extending in a first direction, the upright comprising a toothed bar which comprises first teeth projecting in a second direction perpendicular to the first direction;
at least a climbing means for a vehicle capable of moving along said upright in the first direction, the climbing means comprising a cogwheel which has a rotation axis and which includes, at its periphery, second teeth projecting radially relative to the rotation axis, the second teeth of the cogwheel being adapted to mesh with the first teeth of the toothed bar, characterized in that said at least one upright and said at least one climbing means comprise associated first guiding means configured to cooperate with each other over an engagement movement of the climbing means towards the upright at least in the second direction, in order to guide the cogwheel of the climbing means in the first direction into an engaged position in which the second teeth of the cogwheel mesh with the first teeth of the toothed bar, the rotation axis of the cogwheel extending in a third direction perpendicular to the first direction and to the second direction in the engaged position.

The first direction can coincide with the vertical direction. The second direction and the third direction can coincide with horizontal directions.

The first guiding means of the upright and of the climbing means can be configured to cooperate, their shape being complementary to each other.

The first guiding means of the upright can comprise a first guiding face extending in the second direction, in whole or in part, in an inclined manner at least in the first direction. The first guiding means comprise a first bearing member, the first bearing member being configured to move along the first guiding face between an initial position and a final position over the engagement movement of the climbing means. The final position of the first bearing member on the first bearing face is chosen to coincide with the engaged position of the cogwheel.

The cogwheel and the first bearing member can be fixed relative to each other at least in the first direction.

The first bearing member can comprise a wheel configured to roll along the first guiding surface over the engagement movement of the climbing means.

The climbing means can comprise a support, the cogwheel being pivotally mounted on the support about the rotation axis and the first bearing member being mounted on the support.

The wheel can be pivotally mounted on the support about a first axis.

The upright can comprise a support arranged at one end of the toothed bar, the support comprising at least one side wall which extends in the second direction, said side wall comprising the first guiding face.

Said at least one upright and said at least one climbing means can comprise associated second guiding means configured to cooperate with each other over an engagement movement of the climbing means. in order to guide the cogwheel of the climbing means at least in the third direction into the engaged position.

The second guiding means of the upright can comprise at least a second guiding face extending in the second direction, in whole or in part, in an inclined manner at least in the third direction. The second guiding means of the climbing means can comprise at least a second bearing member, the second bearing member being configured to move along the second guiding face between an initial position and a final position over the engagement movement of the climbing means. The final position of the second bearing member on the second bearing face can be chosen to coincide with the engaged position of the cogwheel.

The second guiding means of the upright can comprise at least a third guiding face extending in the second direction, in whole or in part, in an inclined manner at least in the third direction. The second guiding face and the third guiding face can have respective inclinations opposite each other in the third direction. The second guiding means of the climbing means can comprise at least a third bearing member, the third bearing member being configured to move along the third guiding face between an initial position and a final position over the engagement movement of the climbing means. The final position of the third bearing member on the third bearing face can be chosen to coincide with the engaged position of the cogwheel.

The assembly can comprise a vehicle, preferably for an automated storage and retrieval system, the vehicle comprising a chassis and said at least one climbing means, said at least one climbing means being movable relative to the chassis between a retracted position and a deployed position in which the cogwheel is in the engaged position.

The upright can be fixed to the ground, and the vehicle can comprise rolling means, the rolling means being in contact with the ground when said at least one climbing means is in its retracted position, to allow the vehicle to move on the ground, and at a distance from the ground when said at least one climbing means is in its deployed position.

The upright can be fixed to the ground and the vehicle can comprise rolling means, said at least one climbing means being connected to the chassis of the vehicle by a deployment mechanism having a degree of mobility in the first direction such that the rolling means are in contact with the ground both when said at least one climbing means is in its retracted position and in its deployed position.

According to another aspect, there is provided an engagement method for engaging at least one climbing means with at least one upright for a storage rack, said upright extending in a first direction and comprising a toothed bar which comprises first teeth projecting in a second direction perpendicular to the first direction. The climbing means can be intended for a vehicle capable of moving along the upright in the first direction, the climbing means comprising a cogwheel which has a rotation axis and which includes, at its periphery, second teeth projecting radially relative to the rotation axis, the second teeth of the cogwheel being adapted to mesh with the first teeth of the toothed bar,
the method comprising an engagement movement of the climbing means towards the upright in the second direction, with the rotation axis of the cogwheel perpendicular to the first direction and to the second direction, over which first guiding means cooperate with each other in order to guide the cogwheel of the climbing means in the first direction into an engaged position in which the second teeth of the cogwheel mesh with the first teeth of the toothed bar.

### BRIEF DESCRIPTION OF THE DRAWINGS

Other features, details and advantages will become apparent from reading below detailed description, and from the attached drawings, in which:

FIG. 1 is a side view of an assembly comprising a cogwheel of a vehicle climbing means, engaged with a toothed bar of a storage rack upright.

FIG. 2 is a perspective view of the assembly of FIG. 1.

FIG. 3 is another perspective view of the assembly of FIG. 1 according to an alternative embodiment.

FIG. 4 is a bottom view of the assembly of FIG. 3.

FIG. 5 shows a storage rack comprising the upright of FIGS. 1 to 4.

FIG. 6 partially shows the storage rack of FIG. 5 and a vehicle comprising the climbing means of FIGS. 1 to 4.

### DETAILED DESCRIPTION

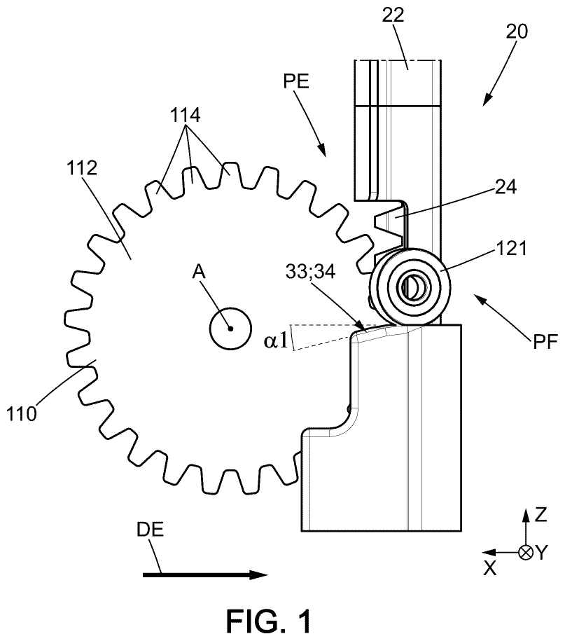

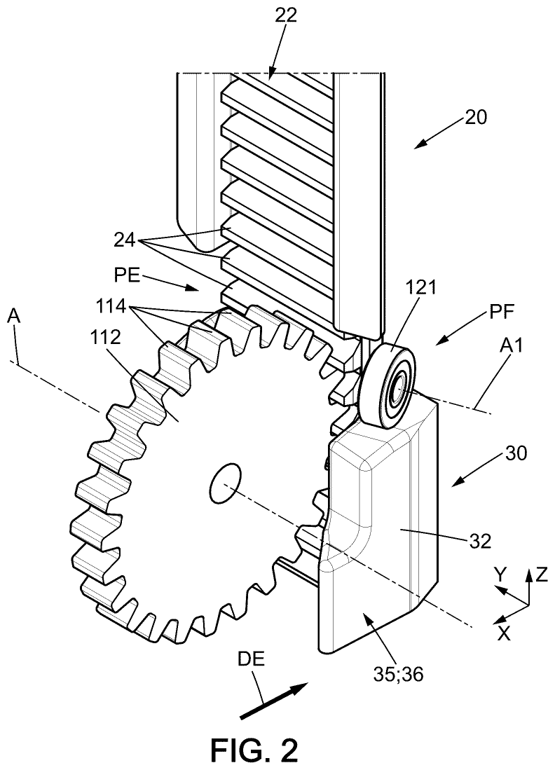

Reference is now made to FIGS. 1 and 2 which represent an assembly comprising at least one upright 20 and at least one climbing means 110.

Said at least one upright 20 is intended for a storage rack 10. The upright 20 extends in a first direction Z. The first direction Z comprises at least one component in a vertical direction, which corresponds to the direction of the gravity field, and preferably coincides with the vertical direction. The upright 20 comprises a toothed bar 22 which comprises first teeth 24 projecting in a second direction X perpendicular to the first direction Z.

Said at least one climbing means 110 is intended for a vehicle 100 capable of moving along said upright 20 in the first direction Z. The climbing means 110 comprises a cogwheel 112 which has a rotation axis A. The cogwheel 112 comprises, at its periphery, second teeth 114, projecting radially relative to the rotation axis A. The second teeth 114 of the cogwheel 112 are adapted to mesh with the first teeth 24 of the toothed bar 22.

Remarkably, said at least one upright 20 and said at least one climbing means 110 comprise first guiding means 34; 121 configured to cooperate with each other over an engagement movement DE of the climbing means 110 towards the upright 20 at least in the second direction X. This results in guiding the cogwheel 112 of the climbing means 110 in the first direction Z into an engaged position PE, visible in FIGS. 1 and 2, in which the second teeth 114 of the cogwheel 112 mesh with the first teeth 24 of the toothed bar 22. As shown, in the engaged position, the rotation axis A of the cogwheel 112 extending in a third direction Y perpendicular to the first direction Z and to the second direction X. Thus, the engagement movement DE can be performed with the rotation axis A of the cogwheel 112 extending, preferably while remaining fixed, in the third direction Y.

In other words, said at least one upright 20 comprises first guiding means 34 and said at least one climbing means 110 comprises guiding means 121, the respective first guiding means 34; 121 of the upright 20 and of the climbing means 110 associating with each other over the engagement movement DE of the climbing means 110 so as to guide the cogwheel 112 in the first direction E into the engaged position PE.

The respective first guiding means 34; 121 of the upright 20 and of the climbing means 110 will be described in more detail below.

This ensures with certainty that the second teeth 114 of the cogwheel 112 are engaged with the first teeth 24 of the toothed bar 22. In other words, this makes it possible to avoid “tooth against tooth” contact between the cogwheel 112 and the toothed bar 22, which would prevent movement of the first climbing means 110, and consequently of the corresponding vehicle 100, along the toothed bar 22 in the first direction Z. Indeed, the arrangement of associated first guiding means 34; 121, configured to cooperate with each other during the engagement movement of the climbing means 110 towards the upright 20, ensures precise alignment of the cogwheel 112 with the toothed bar 22 in the first direction Z. As a result, the reliability of the climbing means 110 of the vehicle 100 is improved, in particular when moving along the toothed bar 22 in the first direction Z. This notably reduces the impact of variations such as the position of the rack 10, the ground flatness tolerances and the manufacturing tolerances of the toothed bar 22 and/or of the climbing means 110, or even of the vehicle 100.

The specific arrangement according to which the rotation axis A of the cogwheel 112 extends in a third direction Y, perpendicular to the first direction Z and to the second direction X, contributes to a more stable and better controlled engagement process.

In its engaged position PE, the cogwheel 112 can be capable of moving along the toothed bar 22 in the first direction Z. In its engaged position PE, the rotation axis A of the cogwheel 112 can extend in the third direction Y.

The first guiding means 34; 121 of the upright 20 and of the climbing means 110 can be configured to cooperate, their shape being complementary to each other. The shape complementarity between the first guiding means 34; 121 of the upright 20 and the climbing means 110 facilitates a smoother engagement, with less jerks, of the cogwheel 112 with the toothed bar 22. This reduces component wear and helps extend system life, while enabling higher operating speeds and improved efficiency during the engagement process.

More particularly, the first guiding means 34; 121 of the upright 20 can comprise a first guiding face 34 extending in the second direction X, in whole or in part, in an inclined manner at least in the first direction Z. In other words, an axis perpendicular to the first guiding face 34 can extend in an inclined direction relative to the first direction Z, that is to say it can extend in a direction which includes at least one component in the first direction Z and at least one component in the second direction X and possibly a component in the third direction Y. The first guiding means 34; 121 of the climbing means 110 can comprise a first bearing member 121. The first bearing member 121 is configured to move along the first guiding face 34 between an initial position and a final position PF, visible in FIGS. 1 and 2, over the engagement movement DE of the climbing means 110. The final position PF of the first bearing member 121 on the first bearing face can be chosen to coincide with the engaged position PE of the cogwheel 112. The cogwheel 112 and the first bearing member 121 can be fixed relative to each other at least in the first direction Z. Guiding the first bearing member 121 in the first direction Z along the first guiding face 34 to its final position PF makes it possible to correct, over the engagement movement DE, a position error of the cogwheel 112, and subsequently of the corresponding vehicle 100, relative to the engaged position PE in the first direction Z. This thus makes it possible to ensure that the cogwheel 112 engages the toothed bar 22, i.e., by avoiding a “tooth against tooth” contact between the cogwheel 112 and the toothed bar 22 which would disturb, or even prevent, engagement.

When the cogwheel 112 is said to be “engaged” with the toothed bar 22, it is understood that the second teeth 114 mesh with the first teeth 24.

It is understood that the first bearing member 121 can be moved between the initial position and the final position PF by a ramp effect on the first guiding face 34. Thus, the first bearing member 121 can be moved in the first direction Z between the initial position and the final position PF. In other words, the initial position and the final position PF of the first bearing member 121 can be offset from each other in the first direction Z. A first inclination angle α1 of the first guiding face 34 relative to a plane comprising the second direction X can be between 0° and 25°.

The initial position of the first bearing member 121 on the first guiding face 34 corresponds to the position of the first bearing member 121 when the latter comes into contact with the first bearing face. Depending on the flatness of the ground on which the vehicle 100 is moving, depending on the clearances along the first direction Z in the deployment of the climbing means 110 or even depending on the manufacturing tolerances of the climbing means 110 and the upright 20, the initial position of the first bearing member 121 on the first guiding face 34 can vary along the first direction Z and/or the second direction X.

In order to further facilitate meshing the second teeth 114 with the first teeth 24, the position of the second teeth 114 about the rotation axis A of the cogwheel 112 can be predetermined and fixed during the engagement movement DE. In particular, the position of the second teeth 114 about rotation axis A of the cogwheel 112 can be determined to allow engaging with the first teeth 24 of the toothed bar 22 when the cogwheel 112 is positioned in the first direction Z at the engagement position.

The first bearing member 121 can comprise a wheel, or even a roller or a ramp, configured to roll along the first guiding surface over the engagement movement DE of the climbing means 110. This rolling action reduces friction and wear on the components, increasing durability and reducing maintenance requirements. This rolling action ensures constant contact between the first bearing member 121 and the inclined first guiding surface of the centering member, which allows more reliable and more precise positioning of the cogwheel 112 in the first direction Z during the engagement process.

The climbing means 110 can comprise a support 111. The cogwheel 112 can be pivotally mounted on the support 111 about rotation axis A. This arrangement provides additional structural integrity, ensuring that the cogwheel 112 maintains proper orientation and engagement with the toothed bar 22 throughout the engagement process. Likewise, the first bearing member 121 can be mounted on the support 111. More particularly, the wheel can be pivotally mounted on the support 111 about a first axis A1. An extension direction of the first axis A1 can comprise at least one component along an extension direction of the rotation axis A of the cogwheel 112. According to a particular case, the first axis A1 can be parallel to the rotation axis A of the wheel. Alternatively, the first axis A1 can be inclined relative to the rotation axis A of the cogwheel 112. For example, when the rotation axis A of the cogwheel 112 extends in the third direction Y, the first axis A1 can extend at least in the third direction Y, and can also extend in the first direction Z and/or the second direction X.

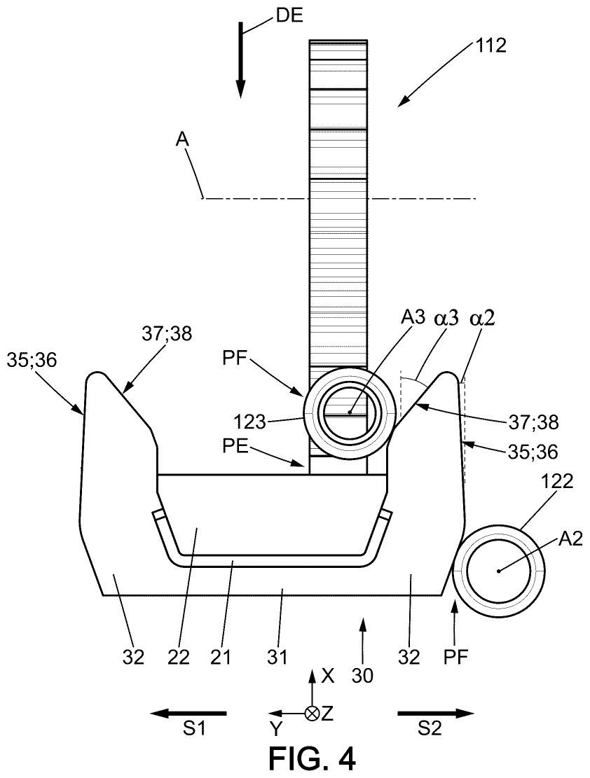

The upright 20 can comprise a support 30 arranged at one end of the toothed bar 22, preferably a lower end of the toothed bar. The support 30 is more particularly visible in FIG. 4 which will be described in detail later. The support 30 can comprise at least one side wall 32 which extends in the second direction X. Said at least one side wall 32 can comprise the first guiding face 34.

The support 30 can comprise a central wall 31. Said at least one side wall 32 can extend in the second direction X from the central wall 31. Said at least one side wall 32 can be arranged laterally to the first teeth 24 of the toothed bar 22 in the third direction Y. Said at least one side wall 32 can comprise an upper face 33, in particular opposite the ground in the first direction Z. The upper face 33 of said at least one side wall 32 can comprise the first bearing face.

The upright 20 can comprise a post 21 which extends in the first direction Z. The toothed bar 22 can be fixed to the post 21. The support 30 can also be fixed to the post 21. In particular, post 21 can comprise a front face and a rear face, opposite each other in the second direction X. The toothed bar 22 can then be fixed to the post 21 at the front face, and/or the support 30 can be fixed to the post 21 at the rear face.

Said at least one side wall 32 can comprise two side walls 32. In other words, the support 30 can comprise two side walls 32 such as described above with reference to said at least one side wall 32. It is understood that each side wall 32 comprises a respective first guiding face 34. Each side wall 32 can extend in the second direction X from a respective end portion of the central wall 31 in the third direction Y. The support 30 can have a C shape. The toothed bar 22 can be arranged, or even interlocked, between the side walls 32 in the third direction Y.

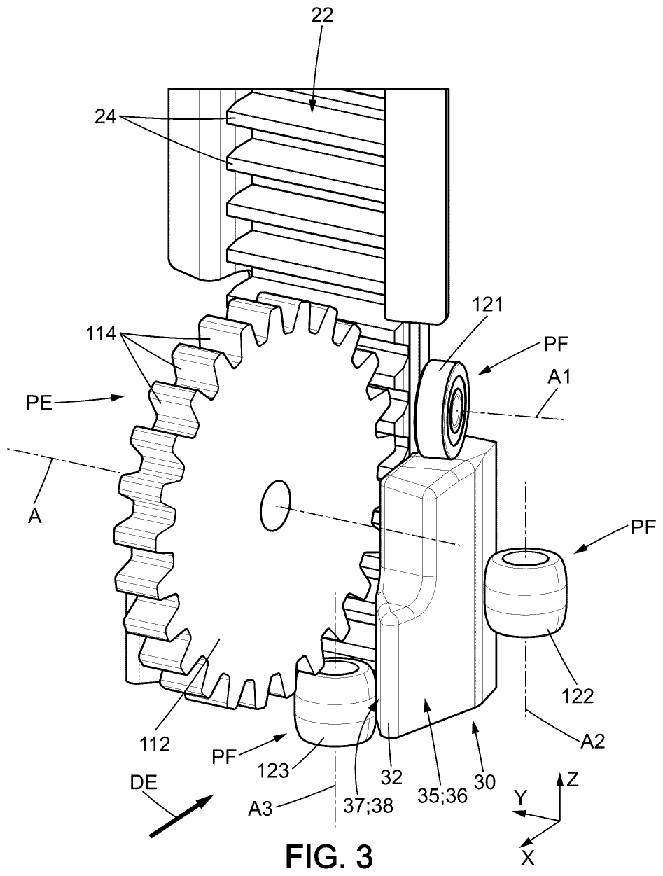

Reference is now made to FIGS. 3 and 4 which represent the same assembly as in FIGS. 1 and 2, except that it additionally comprises second guiding means 36; 122; 38; 123. More particularly, said at least one upright 20 and said at least one climbing means 110 comprise associated second guiding means 36; 122; 38; 123 configured to cooperate with each other over an engagement movement DE of the climbing means 110. This results in guiding the cogwheel 112 of the climbing means 110 at least in the third direction Y into the engaged position PE. This ensures a correct position of the second teeth 114 of the cogwheel 112 relative to the first teeth 24 of the toothed bar 22 in the third direction Y.

The second guiding means 36; 122; 38; 123 of the upright 20 and of the climbing means 110 can be configured to cooperate, their shape being complementary to each other.

The toothed bar 22 can comprise a first lateral edge and a second lateral edge on each side in the third direction Y. In its engaged position PE, the cogwheel 112 can be closer in the third direction Y to one of the first lateral edge and the second lateral edge than to the other of the first lateral edge and the second lateral edge. In other words, in its engaged position PE, the cogwheel 112 can be off-center relative to a median position on the toothed bar 22 in the third direction Y. Alternatively, in the engaged position PE, the cogwheel 112 can be equidistant from each of the first lateral edge and the second lateral edge of the toothed bar 22. Or in other words, in its engaged position PE, the cogwheel 112 can be centered relative to a median position on the toothed bar 22.

The second guiding means 36; 122; 38; 123 of the upright 20 can comprise at least a second guiding face 36 extending in the second direction X, in whole or in part, in an inclined manner at least in the third direction Y. In other words, an axis perpendicular to the second guiding face 36 can extend in an inclined direction relative to the third direction Y, that is to say it can extend in a direction which includes at least one component in the second direction X and at least one component in the third direction Y and possibly a component in the first direction Z. The second guiding means 36; 122; 38; 123 of the climbing means 110 can comprise at least a second bearing member 122. The second bearing member 122 can be configured to move along the second guiding face 36 between an initial position and a final position PF over the engagement movement DE of the climbing means 110. The final position PF of the second bearing member 122 on the second bearing face can be chosen to coincide with the engaged position PE of the cogwheel 112. Guiding the second bearing member 122 in the third direction Y along the second guiding face 36 into its final position PF makes it possible to correct, over the engagement movement DE, a positioning error in a first orientation S1 of the third direction Y of the cogwheel 112 relative to the desired engaged position PE, or even an overall positioning error of the corresponding vehicle 100 in the third direction Y.

It is understood that the second bearing member 122 can be moved between the initial position and the final position PF by a ramp effect on the second guiding face 36. Thus, the second bearing member 122 can be moved in the third direction Y between the initial position and the final position PF. In other words, the initial position and the final position PF of the second bearing member 122 can be offset from each other in the third direction Y.

In addition, the second guiding means 36; 122; 38; 123 of the upright 20 can comprise at least a third guiding face 38 extending in the second direction X, in whole or in part, in an inclined manner at least in the third direction Y. In other words, an axis perpendicular to the third guiding face 38 can extend in an inclined direction relative to the third direction Y, that is to say it can extend in a direction which includes at least one component in the second direction X and at least one component in the third direction Y and possibly a component in the first direction Z. The second guiding face 36 and the third guiding face 38 can have respective inclinations opposite each other in the third direction Y. Likewise, the second guiding means 36; 122; 38; 123 of the climbing means 110 can comprise at least a third bearing member 123. The third bearing member 123 can be configured to move along the third guiding face 38 between an initial position and a final position PF over the engagement movement DE of the climbing means 110. The final position PF of the third bearing member 123 on the third bearing face can be chosen to coincide with the engaged position PE of the cogwheel 112. Guiding the third bearing member 123 in the third direction Y along the third guiding face 38 into its final position PF makes it possible to correct, during the engagement movement DE, a positioning error in a second orientation S2 of the third direction Y of the cogwheel 112 relative to the desired engaged position PE, or even an overall positioning error of the corresponding vehicle 100 in the third direction Y.

It is understood that the third bearing member 123 can be moved between the initial position and the final position PF by a ramp effect on the third guiding face 38. Thus, the third bearing member 123 can be moved in the first direction Z between the initial position and the final position PF. In other words, the initial position and the final position PF of the third bearing member 123 can be offset from each other in the first direction Z.

The second guiding face 36 and the third guiding face 38 can be opposite each other in the third direction Y. A second inclination angle α2 of the second guiding face 36 relative to a plane comprising the second direction X can be different or equal, in absolute value, to a third inclination angle α3 of the third guiding face 38 relative to a plane comprising the second direction X. The second inclination angle α2 of the second guiding face 36 and/or the third inclination angle α3 of the third guiding face 38 can be between 0° and 25°.

Said at least one side wall 32 can comprise the second guiding face 36 and/or the third guiding face 38. Said at least one side wall 32 can comprise an internal face 37. The internal face 37 of the side wall 32 can be facing, or even bearing on, an edge of the toothed bar 22 in the third direction Y. Said at least one side wall 32 can comprise an external face 35. The external face 35 of the side wall 32 can be opposite an edge of the toothed bar 22 in the third direction Y. The inner face 37 and the outer face 35 of said at least one side wall 32 can be opposite each other. The external face 35 can comprise the second guiding face 36. The internal face 37 can comprise the third guiding face 38.

The second bearing member 122 and/or the third bearing member 123 can comprise a wheel configured to roll respectively along the second bearing face and along the third bearing face over the engagement movement DE of said at least one climbing means 110.

The wheel of the second bearing member 122 can be mounted on the support 111 about a second axis A2. The second axis A2 can extend along the first direction Z. The wheel of the third bearing member 123 can be mounted on the support 111 about a third axis A3. The third axis A3 can extend along the first direction Z.

More generally, it is understood that the second guiding means 36; 122; 38; 123 of the upright 20 and of the climbing means 110 can be configured to cooperate, their shape being complementary to each other.

An alternative embodiment, not shown, of the second guiding means 36; 122; 38; 123 is now described. Said at least one upright 20 can comprise a first upright 20 and a second upright 20 spaced away from each other in the third direction Y. Said at least one climbing means 110 can comprise a first climbing means 110 and a second climbing means 110, the cogwheel 112 of the first climbing means 110 being adapted to engage the toothed bar 22 of the first upright 20 and the cogwheel 112 of the second climbing means 110 being adapted to engage the toothed bar 22 of the second upright 20. The first climbing means 110 and the second climbing means 110 can be intended for a single vehicle 100 capable of moving simultaneously along the first upright 20 and the second upright 20 along the first direction Z. More specifically, each of the first climbing means 110 and the second climbing means 110 can be movably mounted on the chassis 101 of the vehicle 100 between a respective retracted position and a deployed position. The second guiding means 36; 122; 38; 123 of the first upright and of the second upright 20 can each only comprise the second guiding face 36. Similarly, the second guiding means 36; 122; 38; 123 of the first climbing means 110 and of the second climbing means 110 can each only comprise the second bearing member 122. The second guiding face 36 of the first upright 20 and the second guiding face 36 of the second upright 20 can have an inclination opposite each other with respect to the third direction Y. 20

Thus, guiding the second bearing member 122 of the first climbing means 110 in the third direction Y along the second guiding face 36 of the first upright 20 into its final position PF makes it possible to correct, over the engagement movement DE, a positioning error in the second orientation of the third direction Y of the cogwheels 112 of the first climbing means 110 and of the second climbing means 110 relative to their desired engaged positions PE, or even an overall positioning error of the corresponding vehicle 100 in the third direction Y.

Similarly, guiding the second bearing member 122 of the second climbing means 110 in the third direction Y along the second guiding face 36 of the second upright 20 into its final position PF makes it possible to correct, over the engagement movement DE, a positioning error in the first orientation of the third direction Y of the cogwheels 112 of the first climbing means 110 and of the second climbing means 110 relative to their desired engaged positions PE, or even an overall positioning error of the corresponding vehicle 100 in the third direction Y.

This alternative makes it possible to avoid a third guiding face 38 and a third bearing member 123 for the second guiding means 36; 122; 38; 123.

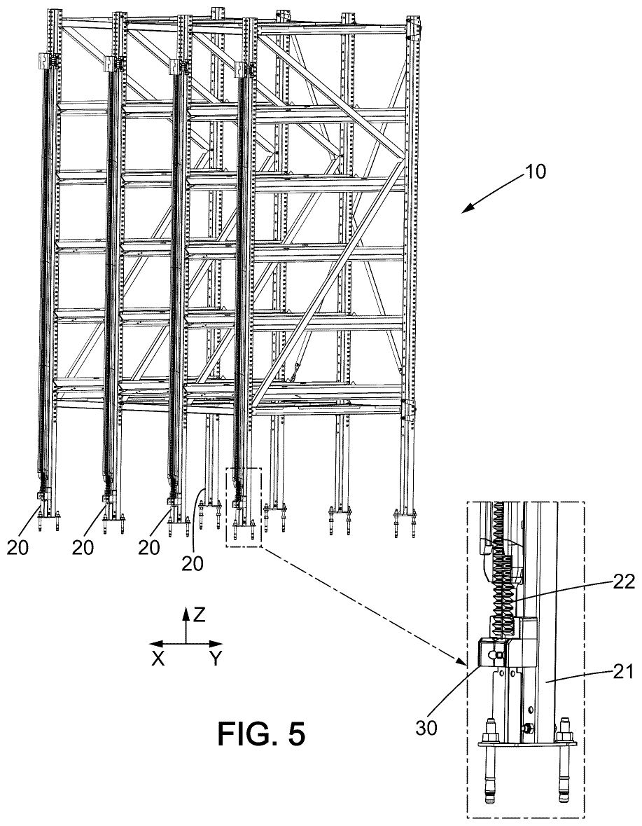

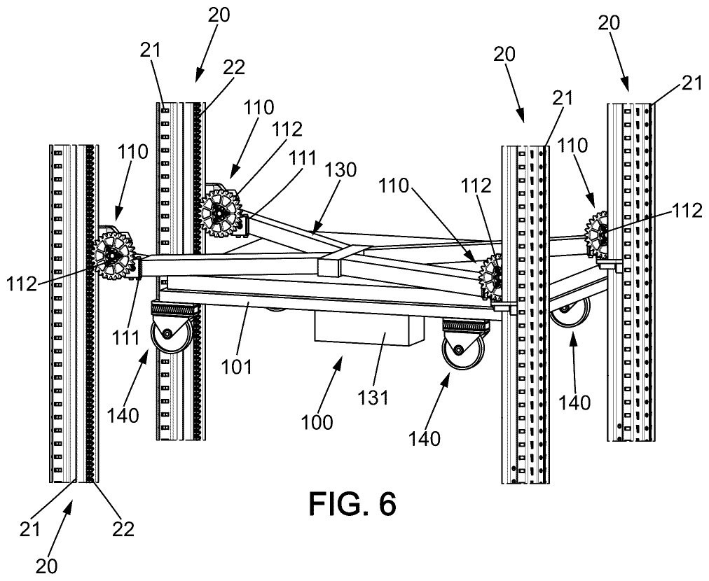

Referring to FIGS. 5 and 6, at least one vehicle 100 and at least one storage rack are now described in more detail. Said at least one vehicle 100 and said at least one storage rack 10 are preferably intended for an automated storage and retrieval system.

Said at least one storage rack 10 can comprise one or more uprights 20 as described above, and aligned in a spaced manner along the third direction Y in the case of a plurality thereof. Rack 10 is adapted to storing items. The vehicle 100 can be intended to retrieve an item from the rack 10, in particular by moving along one or more uprights 20 by means of said at least one climbing means 110. Preferably, the vehicle 100 can move along two uprights 20 of a rack 10 by means of two climbing means 110. More preferably, the vehicle 100 can move along two uprights 20 of two racks 10 arranged facing each other in the second direction X, in particular by means of four climbing means 110.

The vehicle can be automatically guided, i.e., of the “automated guided vehicle” type, or AGV. For this purpose, the vehicle can include on-board guiding means adapted to automatically guiding the vehicle. The vehicle 100 can comprise a chassis 101 and said at least one climbing means 110 as described with reference to FIGS. 1 to 4. Said at least one climbing means 110 can be movable relative to the chassis 101 between a retracted position and a deployed position in which the cogwheel 112 is in the engaged position PE. Said at least one climbing means 110 can come from the retracted position to the deployed position via the engagement movement DE of the climbing means 110. The climbing means 110 can be closer to the chassis 101 in the retracted position than it is in the deployed position. In the retracted position, the climbing means 110 can be, in whole or in part, housed in the chassis 101.

The vehicle 100 can comprise rolling means 140, the rolling means 140 being in contact with the ground when said at least one climbing means 110 is in its retracted position, to allow the vehicle 100 to move on the ground. The rolling means 140 can be mounted on the chassis 101. The rolling means 140 can be motorized. The rolling means 140 can comprise one or more rolling wheels, and in particular at least one motor, preferably a single motor, for actuating said one or more rolling wheels. When each climbing means 110 is in its retracted position, the vehicle 100 can travel on the ground, in particular the vehicle 100 can travel in the second direction X between two uprights 20 adjacent in the third direction Y.

Said at least one climbing means 110 can be at a distance from the ground when said at least one climbing means 110 is in its deployed position. Alternatively, said at least one climbing means 110 can be connected to the chassis 101 of the vehicle 100 by a deployment mechanism 130 having a degree of mobility in the first direction Z such that the rolling means 140 are in contact with the ground both when said at least one climbing means 110 is in its retracted position and in its deployed position. For example, the deployment mechanism 130 can allow free relative movement between the cogwheel 112 and the chassis 101. In other words, the cogwheel 112 can be moved according over a limited stroke in the first direction Z relative to the chassis 101, the chassis 101 preferably remaining fixed. The degree of mobility, or of freedom, of the deployment mechanism 130 can result from intrinsic clearance in the assembled mechanism or can result from a mechanical connection adapted to such movement. The deployment mechanism can for example comprise a deployable arm associated with each climbing means and at the end of which the support 111 of said associated climbing means is fixed. The vehicle 100 can comprise a single motor 131 for deploying each climbing means 110 and/or for driving the cogwheel 112 of each climbing means about its respective rotation axis A.

In order to know and adjust the position of the second teeth 114 of the cogwheel 112 of each climbing means about rotation axis A, an absolute encoder can be provided between the motor 131 and the cogwheel 112, adapted to output the circumferential position of the second teeth 114 about rotation axis A. Alternatively or in addition, a stop can be provided on the chassis 101 against which one of the second teeth 114 of the cogwheel 112 of each climbing means 110 comes bearing in the retracted position and a relative encoder between motor 131 and the cogwheel 112, adapted to output the circumferential position of the second teeth 114 about rotation axis A. Alternatively or in addition, a sensor can be provided, adapted to measure the circumferential position about rotation axis A of at least one of the second teeth 114 and adapted to output the circumferential position of the second teeth 114 about rotation axis A.

Finally, an engagement method for engaging at least one climbing means 110 with at least one upright 20 for a storage rack 10 is described. Said upright 20 extends in a first direction Z and comprises a toothed bar 22 which includes first teeth 24 projecting in a second direction X perpendicular to the first direction Z, and said climbing means 110 is intended for a vehicle 100 capable of moving along the upright 20 in the first direction Z, the climbing means 110 comprising a cogwheel 112 which has a rotation axis A and which includes, at its periphery, second teeth 114 projecting radially relative to the rotation axis A, the second teeth 114 of the cogwheel 112 being adapted to mesh with the first teeth 24 of the toothed bar 22.

The method can comprise an engagement movement DE of the climbing means 110 towards the upright 20 in the second direction X, with the rotation axis A of the cogwheel 112 perpendicular to the first direction Z and to the second direction X, over which first guiding means 34; 121 cooperate with each other in order to guide the cogwheel 112 of the climbing means 110 in the first direction Z into an engaged position PE in which the second teeth 114 of the cogwheel 112 mesh with the first teeth 24 of the toothed bar 22.

By guiding the cogwheel 112 of the climbing means 110 in the first Z direction into an engagement position where the second teeth of the cogwheel 112 mesh with the first teeth 24 of the toothed bar 22, the method ensures precise alignment and engagement between the climbing means 110 and the toothed bar 22. This precise alignment is essential for the vehicle 100 to move along the upright 20 without slipping or becoming misaligned, which could lead to operational inefficiencies or damage the cogwheel 112 and/or the toothed bar 22. The engagement movement of the climbing means 110 towards the upright 20 in the second direction X, with the rotation axis A of the cogwheel 112 kept perpendicular to the first direction Z and to the second direction X, ensures that the cogwheel 112 nears the toothed bar 22 in a controlled manner. Approaching perpendicularly minimizes the risk that the second teeth 114 of the cogwheel 112 strike the first teeth 24 of the toothed bar 22 obliquely, which could lead to wear or breakage. Instead, the teeth engage smoothly, which extends the life of the cogwheel 112 and of the toothed bar 22 and reduces the need for maintenance. The cooperation of the first guiding means 34; 121 during the engagement movement facilitates a stable and controlled meshing process between the cogwheel 112 and the toothed bar 22. This stability is essential for the vehicle 100 to operate reliably as it moves up or down the upright 20, particularly under varying load conditions where the center of gravity of the vehicle 100 can shift, which can affect the meshing dynamics.

1. An assembly comprising:
at least one upright for a storage rack extending in a first direction, the upright comprising a toothed bar which comprises first teeth projecting in a second direction perpendicular to the first direction;
at least a climbing means for a vehicle capable of moving along said upright in the first direction, the climbing means comprising a cogwheel which has a rotation axis and which includes, at its periphery, second teeth projecting radially relative to the rotation axis, the second teeth of the cogwheel being adapted to mesh with the first teeth of the toothed bar, wherein said at least one upright and said at least one climbing means comprise associated first guiding means configured to cooperate with each other over an engagement movement of the climbing means towards the upright at least in the second direction, in order to guide the cogwheel of the climbing means in the first direction into an engaged position wherein the second teeth of the cogwheel mesh with the first teeth of the toothed bar, the rotation axis of the cogwheel extending in a third direction perpendicular to the first direction and to the second direction in the engaged position.

2. The assembly according to claim 1, wherein the first guiding means of the upright and of the climbing means are configured to cooperate, their shape being complementary to each other.

3. The assembly according to claim 1, wherein the first guiding means of the upright comprise a first guiding face extending in the second direction, in whole or in part, in an inclined manner at least in the first direction and the first guiding means of the climbing means comprise a first bearing member, the first bearing member being configured to move along the first guiding face between an initial position and a final position over the engagement movement of the climbing means, the final position of the first bearing member on the first bearing face being chosen to coincide with the engaged position of the cogwheel.

4. The assembly according to claim 3, wherein the cogwheel and the first bearing member are fixed relative to each other at least in the first direction.

5. The assembly according to claim 3, wherein the first bearing member comprises a wheel configured to roll along the first guiding surface over the engagement movement of the climbing means.

6. The assembly according to claim 3, wherein the climbing means comprises a support, the cogwheel being pivotally mounted on the support about the rotation axis and the first bearing member being mounted on the support.

7. The assembly according to claim 5, wherein the wheel is pivotally mounted on a support about a first axis.

8. The assembly according to claim 3, wherein the upright comprises a support arranged at one end of the toothed bar, the support comprising at least one side wall which extends in the second direction, said side wall comprising the first guiding face.

9. The assembly according to claim 1, wherein said at least one upright and said at least one climbing means comprise associated second guiding means configured to cooperate with each other over an engagement movement of the climbing means, in order to guide the cogwheel of the climbing means at least in the third direction into the engaged position.

10. The assembly according to claim 9, wherein the second guiding means of the upright comprise a at least a second guiding face extending in the second direction, in whole or in part, in an inclined manner at least in the third direction. and the second guiding means of the climbing means comprise at least a second bearing member, the second bearing member being configured to move along the second guiding face between an initial position and a final position over the engagement movement of the climbing means, the final position of the second bearing member on the second bearing face being chosen to coincide with the engaged position of the cogwheel.

11. The assembly according to claim 10, wherein the second guiding means of the upright comprise a at least a third guiding face extending in the second direction, in whole or in part, in an inclined manner at least in the third direction. the second guiding face and the third guiding face having respective inclinations opposite each other in the third direction, and wherein the second guiding means of the climbing means comprise at least a third bearing member, the third bearing member being configured to move along the third guiding face between an initial position and a final position over the engagement movement of the climbing means, the final position of the third bearing member on the third bearing face being chosen to coincide with the engaged position of the cogwheel.

12. The assembly according to claim 1, which comprises a vehicle, preferably for an automated storage and retrieval system, the vehicle comprising a chassis and said at least one climbing means, said at least one climbing means being movable relative to the chassis between a retracted position and a deployed position in which the cogwheel is in the engaged position.

13. The assembly according to claim 12, wherein the upright is fixed to the ground and wherein the vehicle comprises rolling means, the rolling means being in contact with the ground when said at least one climbing means is in its retracted position, to allow the vehicle to move on the ground, and at a distance from the ground when said at least one climbing means is in its deployed position.

14. The assembly according to claim 12, wherein the upright is fixed to the ground and wherein the vehicle comprises rolling means, said at least one climbing means being connected to the chassis of the vehicle by a deployment mechanism having a degree of mobility in the first direction such that the rolling means are in contact with the ground both when said at least one climbing means is in its retracted position and in its deployed position.

15. An engagement method for engaging at least one climbing means with at least one upright for a storage rack, said upright extending in a first direction and comprising a toothed bar which comprises first teeth projecting in a second direction perpendicular to the first direction, said a climbing means being intended for a vehicle capable of moving along the upright in the first direction, the climbing means comprising a cogwheel which has a rotation axis and which includes, at its periphery, second teeth projecting radially relative to the rotation axis, the second teeth of the cogwheel being adapted to mesh with the first teeth of the toothed bar. the method comprising an engagement movement of the climbing means towards the upright in the second direction, with the rotation axis of the cogwheel perpendicular to the first direction and to the second direction, over which first guiding means cooperate with each other in order to guide the cogwheel of the climbing means in the first direction into an engaged position in which the second teeth of the cogwheel mesh with the first teeth of the toothed bar.
